(19) United States
(12) Patent Application Publication
(10) Pub. No.: US 2005/0108523 A1
(43) Pub. Date: May 19, 2005

(54) Method and apparatus for collecting remote data

(76) Inventor: Earle West, Morganville, NJ (US)

Correspondence Address: ALLAN J. JACOBSON, 13310 Summit Square Center, Route 413 & Doublewoods Road, Langhorne, PA, 19047, US

(21) Appl. No.: 10/784,551

(22) Filed: Feb. 21, 2004

Related U.S. Application Data
(60) Provisional application No. 60/449,184, filed on Feb. 22, 2003.

(51) Int. Cl. H04L 9/00

(52) U.S. Cl. 713/165

(57) ABSTRACT

A method and apparatus for automatically collecting data from a remote location includes placing a remote appliance at each remote location. The remote appliance establishes network connections by making a scheduled local telephone call to the local ISP to communicate with a central server. Virtual networks are established for the purposes of retrieving data from a remote location, consolidating data from several remote locations. The system permits the establishment of simultaneous multiple shared virtual networks using a common central server.

### FIELD OF INVENTION

The present invention relates to the field of data networks. In particular, the present invention relates to a network and a network node for collecting data. Further, the present invention relates to an apparatus and method for collecting remote business telemetry, including point of sale transaction data, vending machine status data, employee time card data, and remote camera data.

### BACKGROUND OF THE INVENTION

Various data collection systems are known. Some networks couple data collection devices to a central computer via dedicated lines. Other systems use the public switched telephone network to couple remote terminals to a central computer or central sever.

Polling remotely-located modem-equipped devices by establishing a telephone connection from a central computer to each such device is commonly used to harvest electronic sales data or other information from remotely-located business machines. Numerous electronic cash registers (ECRs) and point of sale (POS) systems, such as the Samsung SPS-1000, are designed to be equipped with external or built-in modem to facilitate the answering and receipt of a telephone call from a central computer for this purpose.

For many remote systems that are polled from a central computer, the telephone line used for polling may be economically shared with other business uses, for example a fax machine or a conference call. If the telephone line is intended for sharing, a specialized blocking device may also be used to allow only the first user of the telephone line to use the line, so that only one user at a time is allowed.

Alternatively, many businesses have a designated PC operator at each remote site periodically use a PC to collect local cash register data, which is then used to establish a telephone or Internet connection to a central computer for the purpose of transferring local data to the central computer. PCs that perform this function are specially equipped to communicate with the local point of sale system through a local area network connection or a serial RS-232 connection. The PC operator may guide the PC through the operation of first collecting the data from the point of sale system and subsequently transmitting it to the central computer. Alternatively, the PC operator may schedule periodic automatic collection and delivery of data while the operator is away.

For remote business locations that generate a large amount of data to be reported to the central computer, a more costly full time dedicated network connection may be used as an alternative to a shared telephone line. This type of dedicated fill-time communication channel may also used to reach locations that report especially sensitive data that must be kept private and separate from a telephone (or Internet) network that may be shared by the public.

Prior art networks of data collection devices are dedicated to a single application. For example, point of sale terminals from a given manufacturer will typically network only with point of sale terminals from the same manufacturer, and may not be compatible to network with point of sale terminals from other manufacturers. As another example, prior art networks of point of sale terminals are typically dedicated to a one retailer. That is, each retailer has a separate network. While a large retailer may be able to support a dedicated network, small and medium size retailers are underserved by prior art single application systems.

### SUMMARY OF THE INVENTION

The present invention is embodied in a remote appliance for collecting data from a plurality of data collection devices. Each remote appliance is deployed to remote sites. Once installed at the remote site, the remote appliance acts as an automatic device (like a robot) that seeks out the central server by reverse polling through the Internet. Once a connection is made from the remote appliance to the central server, the remote appliance is configured via the central server so as to form a network of data collection devices.

The present invention provides for using the Internet, specifically, dial Internet access, together with the remote placement of a local telephone call to enable a secure session to be established between the remote appliance and a central server (a networked computer) in a way that is economical, avoiding the need for full-time wireless, wireline, or a dedicated Internet access arrangement.

The present system permits the establishment of simultaneous multiple shared virtual networks using a common central server. Virtual simultaneous networks are established for the several purposes: 1) retrieving data from a single remote location, 2) consolidating data from several remote locations and 3) simultaneously operating separate virtual networks from the same central server.

The present system permits point of sale terminals from different manufacturers to be networked together, allowing the consolidation of data from such dissimilar point of sale terminals. The present system permits a single central server to be shared among simultaneous network users. That is, a first group of remote appliances may form a first network using the central server. A second group of remote appliances may form a second network using the same central server. To each group, it appears that there is a separate network. Yet, the multiple groups are sharing a central server in a multiple unit shared virtual network environment i.e., one central server system creating many simultaneous independent data collection networks.

It is a first object of the present invention to establish a means of collecting remote business data in such a way that the high costs of long distance phone calls placed from a central computer to many remote locations, or the high costs of having a PC and a highly paid PC operator at each remote site, and/or the high costs of a full-time Internet access connection (at the remote site) are all avoided. One or more of these types of expenses are characteristic and unavoidable given the present art for collecting remote business data.

It is a second object of the present invention to establish a means of collecting remote business data from a very large number of remote locations, for which there is not enough time in the business day for a central computer to place a telephone or data call to each of the remote sites without interfering with other shared uses of the remote telephone lines. For businesses having tens of thousands of remote sites that must be reached by telephone calls originating at the central computer at night, for example, there are not enough hours at night to accomplish the task, without an very large number of telephone lines at the central computer site.

It is a third object of this invention to provide an un-attended remote data collection device at each remote business site for the purpose of collecting many different kinds of data relevant to the business, and reporting all such data types to a central server. Specifically, this invention is intended to provide for the use of a common device for the collection of electronic cash register data, temperature data, and surveillance camera data, such that a centrally-located computer operator may benefit from a more complete view of remote business operations.

It is a fourth object of this invention to provide for un-attended remote data collection operations such that no person at the remote site can modify, delete, or otherwise interfere with the regular collection of data, and the absence of any person at a remote data collection site will not hinder the regular and reliable delivery of data reported to the central site.

It is a fifth object of this invention to enable information on the configuration, status, and integrity of the remote data collection operations to be accessible to operators at a central site such that continuous operations may be maintained. Should any remote appliance fail to report on schedule, interruptions to the data collection processes should be brought to the attention of the central server operator, who can arrange for replacement devices to be delivered should a remote appliance become impaired.

The above-mentioned and other objects are achieved according to the present invention with a method that combines reverse polling with remote and autonomous Internet dial access techniques. A device connected through serial or LAN interfaces to other devices at the remote site is configured with memory, a modem, a schedule, a configuration file, and a program. As long as the remote appliance is powered on, the program periodically reads the configuration file and according to the schedule file autonomously places a telephone call to a specified Internet point of presence. Reverse polling is this sequence of steps taken by each such remote appliance to autonomously establish its own connection with a central computer for the purpose of posting its own remotely-collected data on its own schedule.

In a preferred embodiment of the invention, the remote appliance is specifically configured uniquely for the remote location such that it dials the nearest Internet access point of presence to that location, from a selection of points of presence available world-wide. This ensures the lowest possible cost for the telephone connection.

In addition, it is also a preferred embodiment of the invention to dial a universal toll-free number the first time it is installed and powered on at the remote location. When such a first-time connection to the central server is established, the central server specifically customizes the configuration of the remote appliance to henceforth dial only the local Internet access telephone number.

It is also a preferred embodiment of the invention whereby the remote appliance encrypts and compresses the data collected from other data collection devices at the remote location. For this purpose, an encryption key is stored in the remote appliance, which later transfers the encrypted data to the central server. Normally, the data files provided by the data collection device are un-encrypted and un-compressed. The encryption key stored in the remote appliance is used to identify the remote appliance to the central server as well as to encrypt data files to be sent to the central server.

Another preferred embodiment of the invention is where the central server maintains a copy of the remote appliance schedules, programs, and configuration files for the purpose of alarming the central system operator in the event one or more remote appliances fails to establish an expected timely connection to the central server.

In another preferred embodiment of the invention a web site at the central server provides to authenticated and authorized Internet web browsers summary data and access to detailed data reported by any or all of the remote appliances.

In one embodiment of the invention the central server consolidates data from many remote appliances and periodically transmits the consolidated data to an accounting application through an XML gateway.

### BRIEF DESCRIPTION OF THE DRAWINGS

FIG. 1 is an overall system block diagram in accordance with the present invention.

FIG. 2 is an overall system flowchart in accordance with the present invention.

FIG. 3 is a remote appliance block diagram in accordance with the present invention.

FIG. 4 is a remote appliance flow chart in accordance with the present invention.

FIG. 5 is a central server block diagram in accordance with the present invention.

FIG. 6 is a central server flow chart in accordance with the present invention.

### DETAILED DESCRIPTION

The described system provides for the economical collection of data from remote business systems such as point of sale terminals, vending machines, fuel pumps, time clocks, and other devices, including security cameras and weather instruments as is needed to facilitate further processing the data at a central data center or displaying remotely collected data on the web, or both. The method is to place at each remote site an autonomous device, which, without any local user intervention, periodically dials out from the remote location to the nearest Internet Service Provider point of presence. Upon establishing a connection to the nearest Internet point of presence, the remote appliance initiates communication with, and securely authenticates itself to a designated central server and reports its collected data. The remote appliance provides additional system maintenance data to the central server, and acquiring software or configuration updates from the central server. Preferably, encrypted and compressed messages are used for all communications between each remote appliance and the central server. Preferably, the central server provides to each remote appliance a local telephone number to be used in reaching a nearby point of presence, ensuring that no toll charges are incurred when a connection is scheduled. A web site at the central server site provides authorized users access to data that is collected from one or more remote appliances, and facilitates updating the remote configuration of each remote appliance, and monitoring the integrity of the entire system. An XML gateway connected to the central server facilitates transmitting consolidated data to a separate payroll and accounting system.

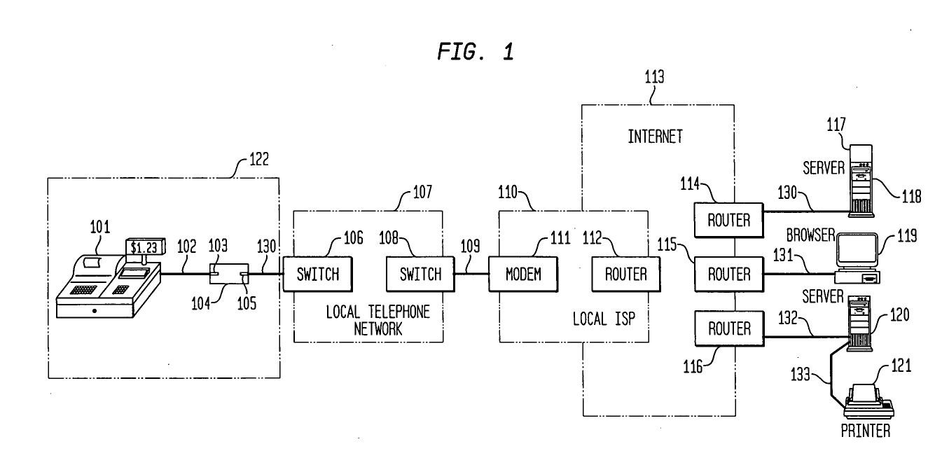

FIG. 1 shows a block diagram of a preferred embodiment of the invention. The purpose here is to periodically harvest information from the remote cash register 01 and, as needed, to remotely control the cash register by delivering updated configuration data to the cash register automatically. While a preferred embodiment shows a cash register 101 as the particular device from which data is collected and transmitted to, many other types of devices may be serviced in the same manner, for example, an automatic vending machine, temperature sensors, video camera sensors, or any other such remote appliance or plurality of remote devices that merit low cost automatic periodic data collection or consolidation to a central server 118 or database 117.

In FIG. 1, cash register 101 is connected to a remote appliance 104 by means of any of several types of cables. In a preferred embodiment of then invention, cash register 101 is connected to remote appliance 104 by means of a serial cable 102 using a standard RS-232C protocol for connecting data terminal equipment (DTE) to data communications equipment (DCE). To facilitate this connection, the remote appliance 104 contains a serial interface port 103.

The remote appliance 104 is shown in more detail in FIG. 3. In this case, the serial port 103 in FIG. 1 is the same component as the block 306 in FIG. 3, and the serial cable 102 in FIG. 1 is the same component as the Cable Connecting Cash Register 309 in FIG. 3. The remote appliance 104 is powered by a power supply shared by the cash register 101 within the place of business 122, or optionally may be powered by batteries. In either case, the remote appliance 104 is always powered on.

The remote appliance 104 also contains a modem 105, also shown in more detail in FIG. 3 as block 307. Connected to the modem 105 is a telephone line 130 connected to a telephone network switching system 106 which is a part of the local telephone network 107. The connection between the modem 105 and the telephone network switching system 106 is also shown as a Telephone Line 310 in FIG. 3.

In a preferred embodiment of this invention, no other devices are connected to the same telephone line 130. However, any other device, such as a telephone, or a fax machine, or even a computer, may be arranged to share the same line, and may use the line for purposes other than those served by this invention. For example, the same telephone line may be used for originating or receiving telephone or data calls so long as the line is not used at the same moment by remote appliance 104 for the purposes of dialing into the local ISP 110 as discussed in more detail below. In a preferred embodiment of this invention, the remote appliance 104 is specifically configured to use the telephone line 130 at times when other uses of the same line are unlikely.

The Local Telephone Network 107 is shown with two switches 106 and 108, each connecting telephone lines 130 and 109, respectively, to subscriber equipment 104, and 111, respectively. In a preferred embodiment of this invention, the modem 105 in the remote appliance 104 transmits Dual Tone Multi-Frequency (DTMF) signals to the local telephone network switch 106, placing a phone call on telephone line 130. The number dialed causes the telephone call to be connected through the Local Telephone Network 107 to a terminating telephone line 109, whereupon the modem 111 that is part of an Internet Service Provider's network 110 answers the call, establishing a local telephone call from the remote appliance 104 to the Local ISP modem 111.

In a preferred embodiment of this invention, modem 111 is part of the Local ISP network 110 which contains a router 112 that is always on the Internet 113. However, the Internet is but one of many other types of networks that may be utilized, subject only to the condition that a Local ISP network 110 has a modem 111 that can be dialed such that answered calls may be connected to a router 112. An Asynchronous Transfer Mode (ATM) or Frame Relay (FR) network, or a private Internet Protocol (IP) network may be used instead.

In the preferred embodiment of this invention, the Local ISP modem 111 is configured to challenge callers for a user account number and password before allowing modem traffic from the remote modem 105 to be routed to the Internet 111. When this is the case, the remote appliance 104 detects the condition and provides the needed account number and password at the right time. When the telephone call is answered by modem 111 and authenticated in this manner, the modem 111 allows traffic to be conveyed to router 112 and thence to other routers on the Internet, including routers 114, 115, and 116 as shown in FIG. 1. An additional level of security may be also optionally realized by arranging the modem 111 to only answer calls that originate from telephone line 130, and/or allowing the account number and password to be valid only for telephone calls originating from line 130. In another embodiment of this invention, the modem 111 may accept all such telephone calls and enable all callers to route data to the Internet 113.

In any and all of the above cases, a modem 105, as directed by the remote appliance 104 connects the remote appliance through the Local Telephone Network 107, using a telephone line 130 that may optionally be shared with other devices. The remote appliance 104 is thus (periodically) connected to any device on the Internet 113, specifically including a centralized server 118 having a database 117.

FIG. 1 shows a server 118 with a database 117 connected by a dedicated full-time cable 130 to an Internet router 114. Also shown is a printer server 120 (typically where an accounting system is located) connected by a dedicated full-time cable to another router 116, and having a printer 121 that is connected by a cable 133 to the printer server 120. In a preferred embodiment of the invention, a Personal Computer (PC) 119 operating a standard HTML web browser is also shown connected to the Internet via cable 131 and Router 115.

It is advantageous for the telephone call connecting the remote appliance 104 to the Local ISP modem 111 to be a local telephone call, thus avoiding long distance charges. One way this advantage is realized is by arranging for the remote appliance 104 to select the telephone number of the nearest Local ISP modem 111.

In a preferred embodiment of the invention the database 117 stores a list of many Local ISP modem telephone numbers and when the remote appliance periodically connects to the server 118 and exchanges reliable authentication information with the server 118, the server 118 transmits messages to the remote appliance 104 as required to configure it to henceforth use a particular telephone number that is known to be associated with the nearest modem 111.

A system operator using a PC with a browser 119 has ready access to control operation of the server 118 and review or change data in the database 117. Furthermore, the server 118 has ready access to a printer server 120 (co-located with the accounting software) that facilitates the printing of reports or other documents on the printer 121.

In a particular embodiment of this invention, the server 118 consolidates data received from one or more remote cash registers 101, each connected to a remote appliance 104 within the same premises 122. The server 118 stores the consolidated data in a database 117, and periodically prints payroll checks 122 on printer 121, consistent with employee time data recorded on the cash register 101. The system thus functions to network cash registers within the same premises 122 that would otherwise be a collection of stand-alone cash registers.

In some point of sale systems, the cash registers 101 within the same premises 122 are networked together by a local area network (LAN). For networked cash registers, one central (master) cash register or a separate computer may function as a local server to consolidate data from all the cash registers 101 located within a single store 122 into a single data file. In such case, only one remote appliance 104 per store 122 is connected to the local central cash register 101/local server is needed to collect consolidated remote data for that store 122.

In the latter embodiment of this invention, the server 118 consolidates data received from one or more remote central cash registers 101, each connected to a remote appliance 104 within each store premises 122. The server 118 stores the consolidated data in a database 117, and periodically prints payroll checks 122 on printer 121, consistent with employee time data recorded on the cash registers 101 for all the stores in a chain of stores. The system thus functions to bring together a plurality of different premises 122 into a single virtual network that would otherwise be a collection of stand-alone stores 122.

In a preferred embodiment of the invention cash register data is queued up within a cash register and is periodically polled by a remote appliance 104 connected to the cash register. This polling is done according to a polling schedule programmed into the remote appliance 104. At the same time, based on a different schedule also programmed into the remote appliance, the remote appliance originates a connection to a Local ISP 111 using a local telephone call through the Local Telephone Network 107 and connected modems (105, 111). The remote appliance uses stored credentials to achieve authorization to access the Internet 113 via the Local ISP Network 107 and establishes a data connection to a central server 118. Having established an Internet connection to a central server, an encrypted and compressed protocol is used to transfer data files created by virtue of having polled the cash register to the central server 118 for processing. The central server 118 processes the data and passes derived data to an XML gateway server 120 that prints checks based on employee time card data originally collected by the cash register.

The connection from the remote appliance 104 to the Local ISP 110 need not be limited only to the use of the Local Telephone Network 107, but may alternatively be a wireless data network, such as an 80211b high capacity wireless LAN connection, or a cellular network, an optical connection, or a satellite access arrangement. Regardless of the specific type of Local ISP access arrangement, the system works in the same way.

The system serves not only one cash register, but a very large number of cash registers, and other types of systems that may record all types of business transaction information, remote equipment status information, remote traffic conditions, and/or remote weather conditions. A remote camera may also be used to report images and image files may be transferred, and/or intermixed with other types of data.

The cash registers need not all belong to one enterprise, but one group of cash registers may belong to one enterprise and another group of cash registers may belong to a separate enterprise. The system formed by a plurality of cash registers (like 101), a plurality of remote appliances (like 104), a plurality of PC's (like 119) and a plurality of print servers/accounting systems (like 120) together with the central server 118, form a network of separate networks coexisting on a unified web site.

A large number of different types of reports could be created from the data delivered to the central server 118, and that data may be manually entered into the central server 118 by a browser 119 and reports generated on the combination of automatically consolidate data and manually-entered data.

The remote appliance 104 can be fixed or portable. It likewise may be independent of the cash register 101 or embedded entirely within the cash register.

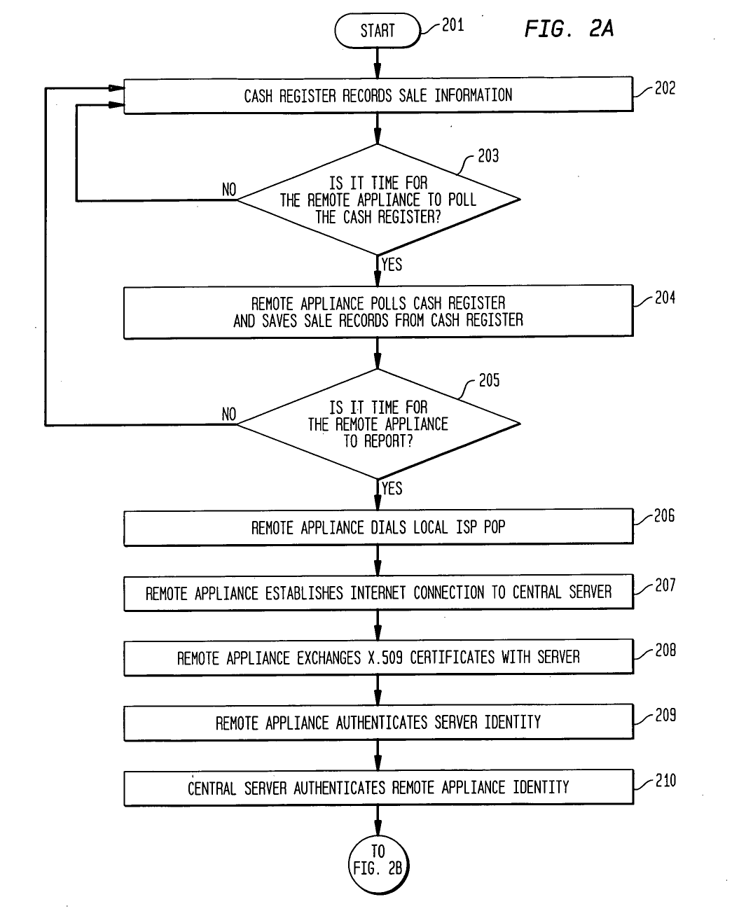

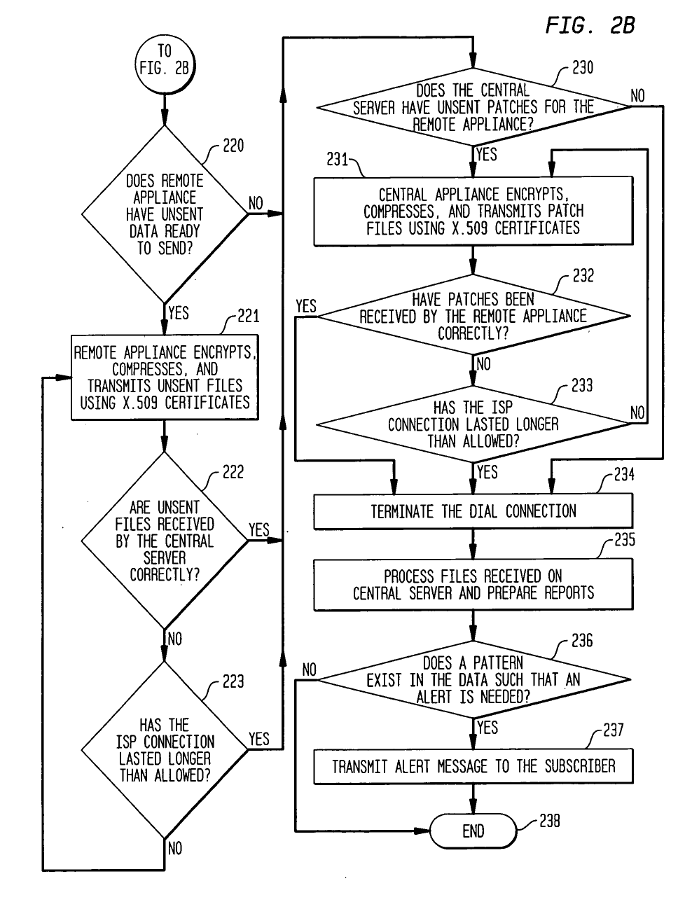

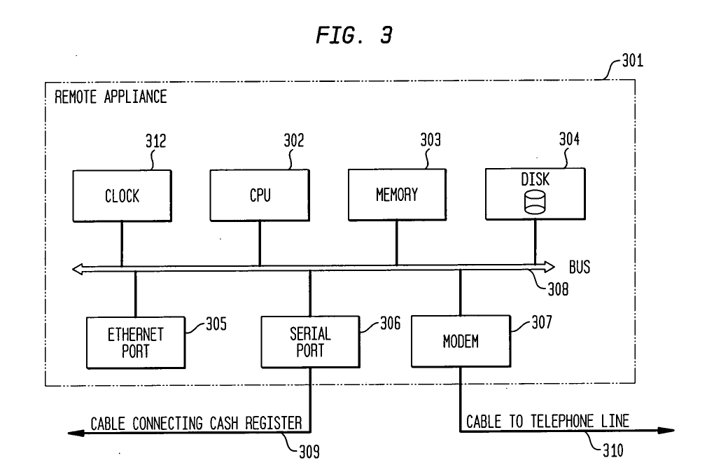

FIG. 2 shows a flow chart of the overall system operation utilizing the components described in FIG. 1. A continuous cycle of repeated operations and decisions begins at starting point 201 and continues to the end 238, only to repeat the cycle, starting at 201 immediately when the end 238 is reached. As long as power is available to each of the components shown in FIG. 1, this overall cycle is continuously repeated. Following the step labeled start 201, the cash register 101 at step 202 is expected to record sales information. The type of information that may be collected by cash register 101 is not limited to sales records, but may also include employee time card data, or any other type of data. In any case, regardless of the particular type of data collected by the cash register 101, the remote appliance 104 is assumed to be powered on and its CPE 302 makes a decision at step 203 as to whether it is time to poll the cash register 101 via the serial link 102, using the serial port 103. In the event that it is not time to poll the cash register, control cycles between steps 202 and 203, enabling the cash register 101 to continue recording information until it is time for the remote appliance to poll the cash register. At the proper point in time, control passes to step 204 where the remote appliance 104 polls the cash register 101 for its data. In a preferred embodiment of the invention, the remote appliance 104 transmits to the cash register 101 a series of messages that cause the cash register to transmit all of the data on sales transactions recorded since the last successful polling event. The remote appliance 104 receives this data and stores it locally in memory 303 or on disk 304. Once the polling activity has completed, control passes to step 205 where the remote appliance conditionally proceeds to connect to the central server 118 via the modem 105, the local telephone line 130, and a connection through the local telephone network 107 to a modem 111 of a Local ISP 110.

In the event it is not time for the remote appliance 104 to connect to the central server 118, control returns to step 202, enabling the cash register 101 to continue operating, while periodically collecting its data as described above, cycling between steps 202 and 203. When the CPU 302 does determine at step 205 that it is time for the remote appliance 104 to dial the local ISP modem 111 (also called a Point of Presence), control passes to step 206 where a telephone connection is established between modems 105 and 111. After establishing such a connection, modem 111 allows traffic to transit the Internet 113 to server 118 in step 207, passing control to step 208. At step 208, the remote appliance 104 and server 118 exchange security credentials, and in a preferred embodiment of the invention, exchange signed X.509 digital certificates attesting to their respective identities. After the remote appliance 104 authenticates the X.509 digital certificate of the server 118 in step 209, and the server 118 authenticates the X.509 digital certificate of the remote appliance 118, control passes to step 220 which is the point where effective, reliable, and secure encrypted messages may be exchanged directly between the remote appliance 104 and the centralized server 118.

At step 220, the remote appliance CPU 302 checks its memory 303 and disk 304 to determine if data has accumulated by virtue of having polled the cash register (between steps 202 and 203) as discussed above. If the answer is yes, having data to send to the central server 118, control passes to step 221 where the data is compressed, encrypted, and sent to the central server 118 based on the prior exchange of signed X.509 certificates at step 208. On the other hand, if no data is ready to be transmitted from the remote appliance 104 to the central server 118, control passes to step 230 where the control server checks to see if it has software or configuration patches to send to the remote appliance 118.

After encrypting and sending one or more data files at step 221, the remote appliance 104 checks at step 222 to see if all of the data files have been successfully encrypted and transmitted to the central server 118. In a preferred embodiment of the invention, this check is performed by comparing check-sums for the data files at the remote appliance and comparing them to check-sums at the central server 118 they are copied to the central server 118. An exchange of encrypted and compressed messages from the central server 118 to the remote appliance 104 facilitates this comparison by the remote appliance CPU 302. If at step 222, there are any data files not yet successfully transferred to the central server, control continues to step 223 to check to see if the telephone call to the Local ISP modem 111 has exceeded an allowed limit. In a preferred embodiment of the invention, a reasonable time limit is stored in the remote appliance memory 303 to ensure the remote appliance has not entered into a state from which it cannot recover. In the event this time limit is exceeded, control passes to step 230 where the central server 118 determines whether or not patches are needed on the remote appliance 104.

At step 230, the central server CPU 513 determines if there are unsent patches that must be sent and applied to the remote appliance 104. If no, then control passes to step 234 where the telephone call is terminated. If the central server 118 does have patches to send and apply to the remote appliance, control passes to step 231 where the central server 118 compresses and encrypts the patch files, in a manner similar to the way data files are sent by the remote appliance 104 to the central server 118 as described above. Control then passes to step 232 where the patches received are verified by comparing check sums. If all patches have been sent correctly, the telephone call is terminated at step 234. If there are remaining patches to be sent at step 232, then at step 233, the central server CPU 513 checks to see if the telephone call has lasted longer than allowed. In a preferred embodiment of the invention, a reasonable number is set to balance the need for adequate time for the data to be transmitted, but to halt the continued use of the telephone line in the event of a system problem. The time limit is stored in the central server memory 514. In any case, when the time limit is exceeded or all of the needed patches have been sent and correctly received by the remote appliance, the telephone call is terminated and control passes to step 236.

At step 236, the central server 118 makes an assessment report of all of the events and decisions made between steps 201 and steps 234 and saves the report on disk 531. Henceforth that report is made accessible for display on any authorized browser 119. After such a report is created, the central server CPU 513 compares values in the report to stored patterns that indicate a need to create an alarm message to the system operator. If any such pattern exists in memory 514 or on disk 530, the CPU 513 transmits an alarm message explaining the condition to one or more subscribers. In a preferred embodiment of the invention, the transmittal is done by sending an email message to a list of email subscribers stored on disk. Once such transmittals are made at step 237 or if no such alarm messages are required at step 236, control passes to step 238 and immediately starts a new cycle of control passing to step 201.

FIG. 3 is a detailed block diagram of remote appliance 104 with cable 309 corresponding to 102; cable 310 corresponding to 130; modem 307 corresponding to 105; and serial port 306 corresponding to 102. The remote appliance is a powered computer having clock 312, CPU 302, memory 303, disk 304, bus 308, and an Ethernet port 305. The Ethernet port 305 is principally used for diagnostic purposes, and in a preferred embodiment of the invention for manufacturing purposes. All components within the remote appliance 301 are powered by batteries, or a common power source shared with the cash register 101.

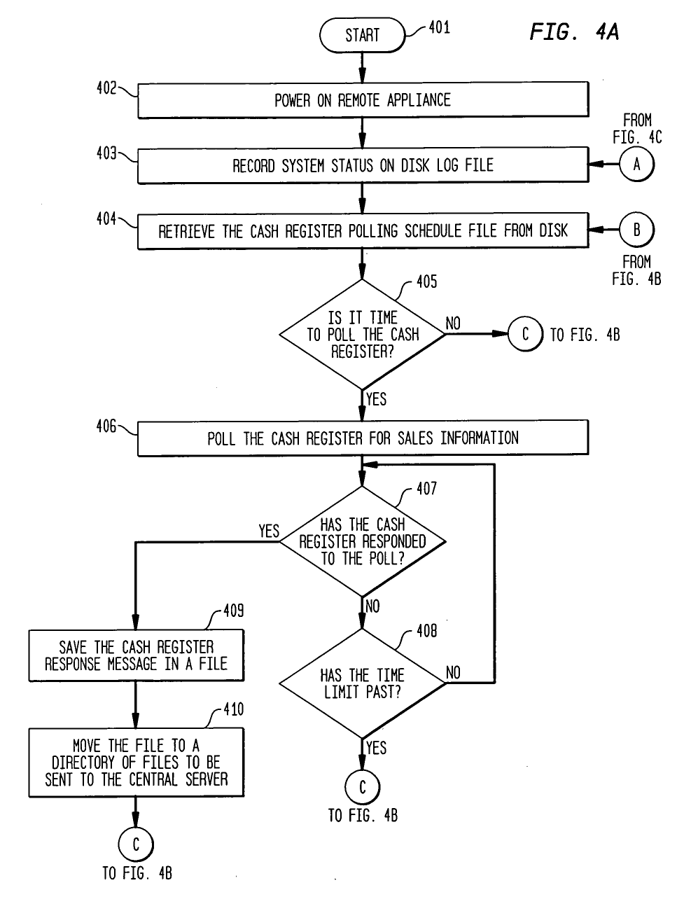

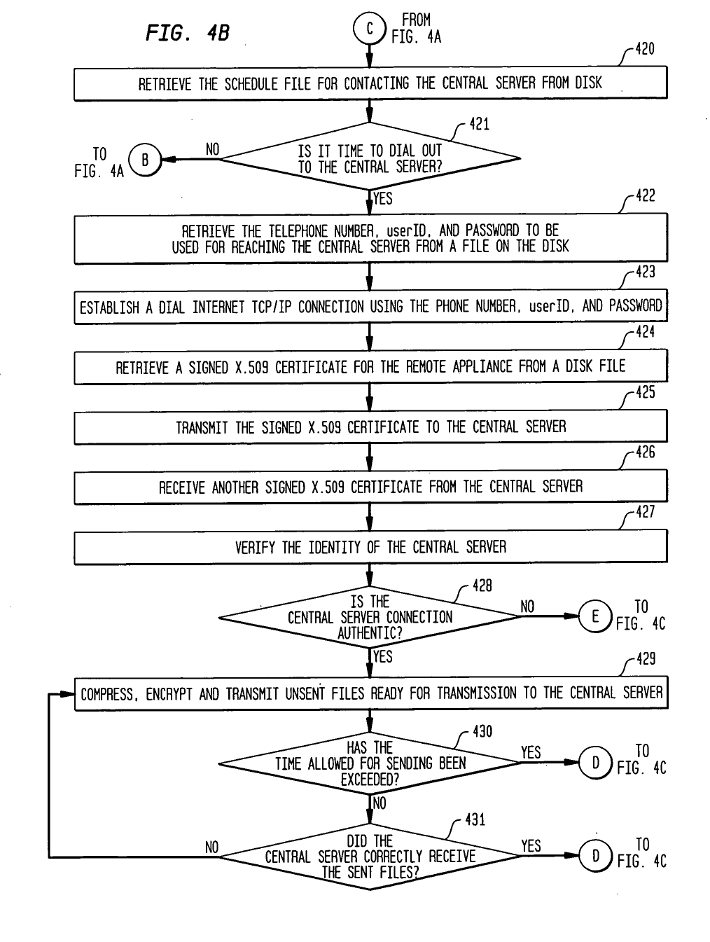

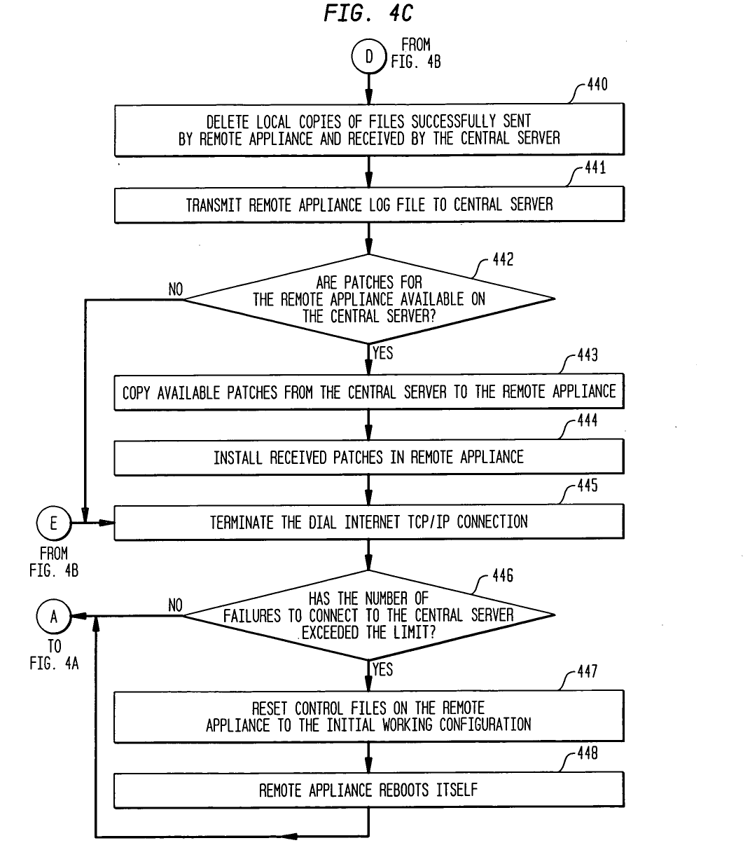

In a preferred embodiment of the invention, the disk 304 is a solid state virtual disk having no moving parts. However, it is easy to see that it may be any type of disk or other persistent magnetic or optical data store. When power is first applied to the remote appliance, all of the components become operational and control passes to a program stored in memory, starting at step 401, as shown in FIG. 4.

In a preferred embodiment of the invention, all of the components of the remote appliance are housed and powered in a stand-alone box separate and apart from all other components shown in FIG. 1. All components of the remote appliance 104 may be housed entirely inside the cash register 101, or inside any other device that may be reporting data to the remote appliance. In any case, the remote appliance operates the same whether it is embedded within the target . . . ion device or not.

FIG. 4 shows the sequence of steps and decisions made by the remote appliance 301. In a preferred embodiment of the invention, the clock 312 is perpetually operating to report the correct time and date to the CPU 302 whenever the CPU and other components are powered on. The clock 312 therefore would be powered by its own independent power source. Beginning at step 401, nothing happens in the remote appliance until power is applied. When all of the components are powered, at step 402, a continuous loop of steps is repeated perpetually, starting with step 403 until power is lost. Step 403 commences the loop by recording the current remote appliance state on disk, passing control to step 404. In a preferred embodiment of the invention, a comprehensive set of system measurements are taken, including the time of day, the disk capacity, the version of software running, and information about software patches that are activated.

At step 404, the remote appliance retrieves from disk 304 the polling schedule for polling the attached cash register 101. At step 405, the CPU 302 compares the clock 312 time to the schedule and determines if it is time to poll the cash register for its data. In the event that it is not time, control passes to step 420. In the event it is time to poll the cash register, the remote appliance sends the poll message at step 406 and waits for the requisite response from the cash register at step 407. If no message is received from the cash register, control passes to step 408 to check to see if a time limit has passed. In a preferred embodiment of the invention, a reasonable time limit is stored in memory to balance the time needed to wait for the cash register to respond against the need to avoid a perpetual state of waiting for an external event that may never arrive. If the time limit has not passed, control passes to step 407 and the remote appliance continues to wait for the cash register to respond. If the time limit for such a response has been exceeded, control passes to step 420.

At step 409, the data received from the cash register 101 via serial link 102 and serial port 306 is stored in a data file on disk 304 and at step 410 moved to a place of storage where all such data files that are to be sent to the central server 118 are stored. Control then passes to step 420.

At step 420, the remote appliance retrieves from disk 304 the schedule for connecting to the central server 118. At step 421, the CPU 302 compares the time on clock 312 with the schedule retrieved and determines if it is time to dial out to the Local ISP 110 for the purpose of connecting to the central server 118. In the event it is not time to make such a connection, control passes to step 404. In the event it is time to make such a connection, the CPU 302 retrieves from memory 303 the telephone number, the user account number and the password to use to connect to the Local ISP 110. At step 423 the remote appliance engages modem 307 to dial the telephone number, and using the account number and password establish an internet connection using the Local ISP router 112.

Upon establishing a connection to the Internet 113, and thence to the server 118, at step 424, the remote appliance sends its signed X.509 certificate to the remote server 118, and at step 426 receives the server's X.509 signed certificate. This enables the remote appliance 103 to verify the identity of the central server 118, and make a decision based on the authenticity of the connection at step 428. In the event the authenticity of the connection cannot be assured at step 428, control passes to step 445 where the connection is terminated. In the event the remote appliance verifies the connection is authentic at step 429, control passes to step 429. At step 429, the remote appliance compresses and encrypts unsent data files that are ready for transmission to the central server 118, transmits such data files to the central server and passes control to step 430 where the CPU determines if the time allowed for such a connection has been exceeded. In a preferred embodiment of the invention, the CPU 302 retrieves a value from memory 303 to determine the time limit, and the time limit value balances the needed to allow for data exchange without allowing external events to isolate the remote appliance in a perpetual state of waiting for an external event. In the event this time limit is exceeded, control passes to step 440. In the event the time limit has not been exceeded, the remote appliance at step 431 determines if the central server has correctly received all of the data files that were sent. If any data files remain unsuccessfully sent, control passes back to step 429 to continue sending such data files. In the event all unsent data files are successfully sent, control passes to step 440.

At step 440, the remote appliance 104, 301 is able to, and proceeds to delete local copies of data files that have been successfully transferred to the central server 118, and control passes to step 441 where the remote appliance 301 delivers a data file containing an account of all remote server component activities in the form of a log file. Recall that a log file updates are made at step 403, however, it is evident that log file updates may be made by any component of the remote appliance 301. After transmitting the log file to the central server 118, control passes to step 442 where the CPU 302 determines if any patches for the remote appliance 301 are ready at the central server 114. If there are no patches at the central server 118 for loading on the remote appliance 301 at this point, control passes to step 445 where the call is terminated. Otherwise, control passes to step 444 where the patch files are transferred from the central server 118 to the remote appliance 301 disk 304 and installed on the remote appliance file system.

At step 445 the telephone call established at step 423 is terminated and control passes to step 446. At step 446 the remote appliance 301 CPU 302 determines if the terminating call is one of a number of failed calls such that the number of failed calls has exceeded a limit stored in memory 303. In a preferred embodiment of the invention the limit number is set to balance the need to detect genuine failures against the need to detect failures quickly. If the limit has been exceeded, then there is a likely fault condition in the remote appliance, and control passes to step 447 wherein files saved within the disk 304 at the point of manufacture, before patches have been applied, are restored such that the memory 303 and disk drive 304 are restored to factory conditions. From this point, control passes to step 448 where the remote appliance power is cycled off and on to reboot the system and control passes to step 403. However, in the event the limit at decision point 446 is not exceeded, control is passed to step 403 without rebooting, perpetually looping through the sequence of control steps between step 403 and 446.

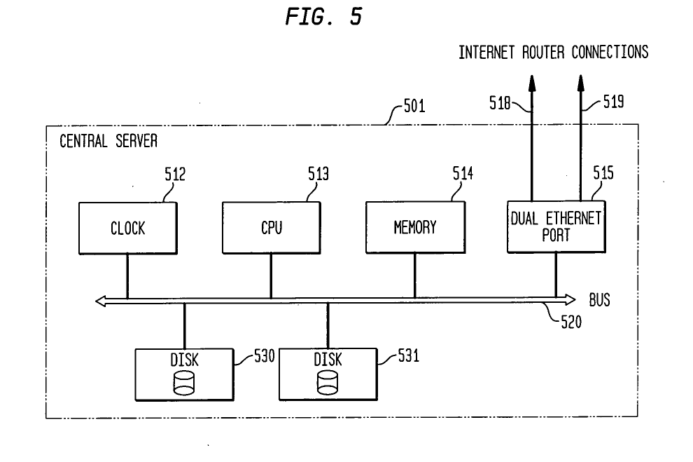

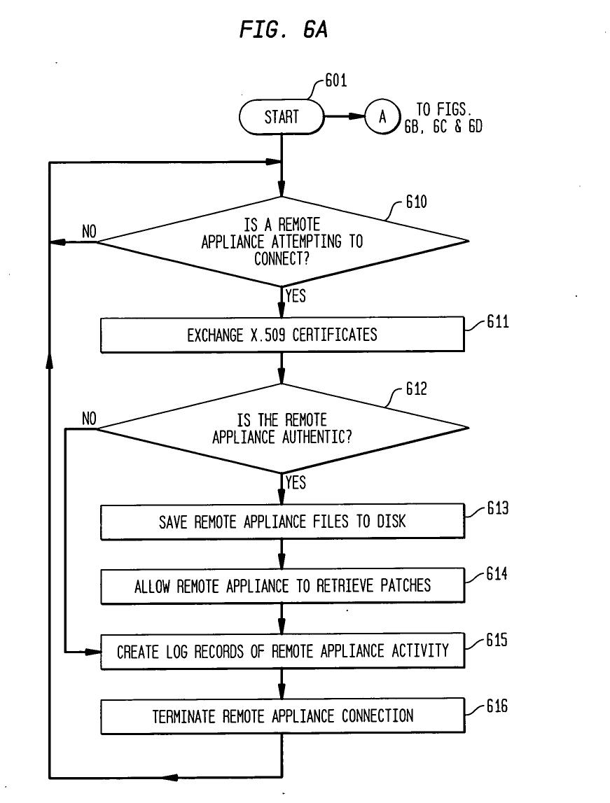

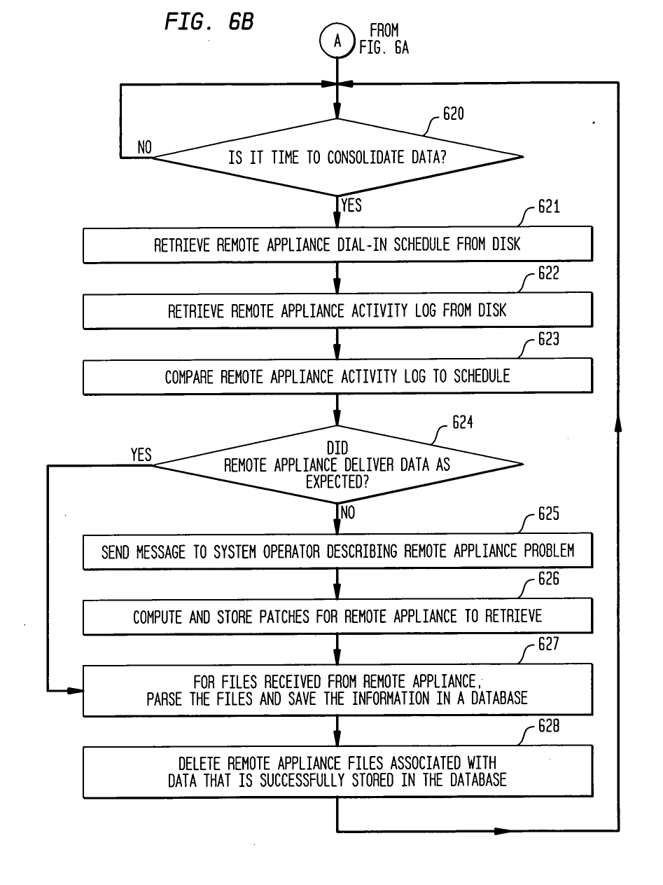

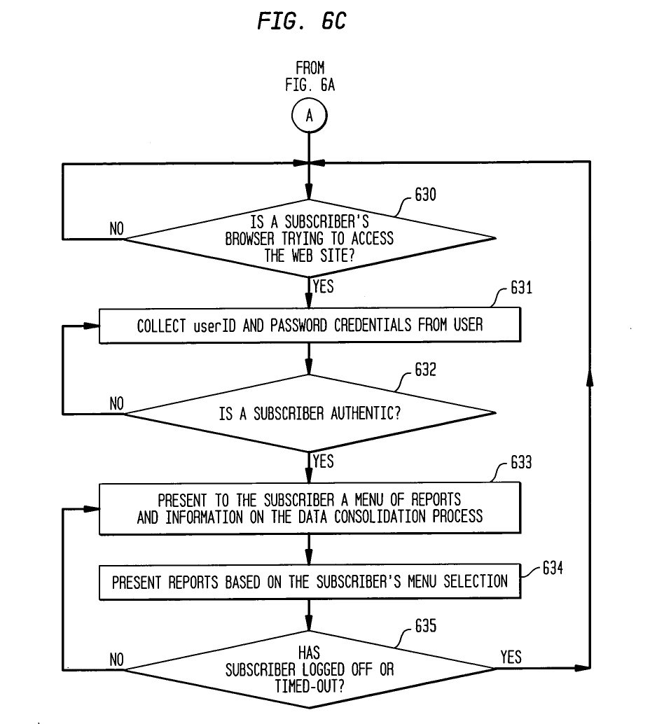

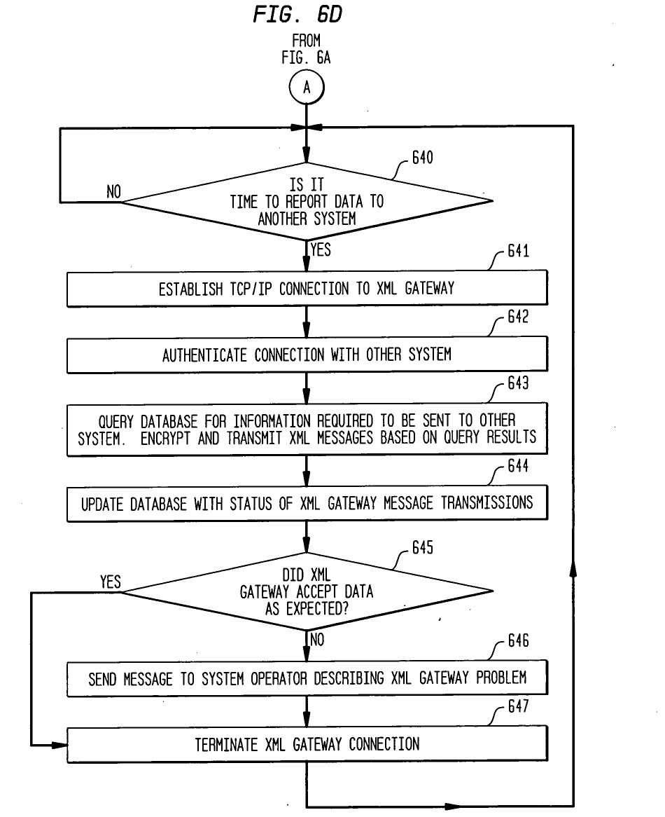

FIG. 5 is a block diagram of the central server 118 in FIG. 1. Cable 130 in FIG. 1 corresponds to the composite Internet Router Connections 518 and 519. The central server 501 is configured to be always powered on, providing a common set of services including File Transfer Protocol (FTP) service, HyperText Transport Protocol (HTTP) service, Secure Copy Protocol (SCP) service, and Simplified Message Transport Protocol (SMTP) electronic mail service. The central server system is composed of a clock 512, a CPU 513, memory 514, a dual ethernet port 515, disks 530, and 531, and a bus 520. In addition, the dual ethernet port is assigned an Internet Protocol address by the administrator of the Internet Router 114 to which the central server 118 is connected. The central server disk 530 is also configured with a digitally-signed X.509 certificate such that any other computer, upon analyzing the X.509 certificate can be assured that the server is the one attested to by the certificate, using commonly available encryption algorithms and protocols for public key—private key cryptography. A remote appliance uses its private key to encrypt outgoing messages. The central server authenticates the received message using the public key of the remote appliance's public/private encryption key pair. Similarly, in standard public key—private key cryptography, the remote appliance may encrypt the outgoing message with the public key of the central server. In such manner, only the central sever having the other (private) key of a public/private key pair can decrypt the received encrypted message.

The central server 501 follows a program that begins upon reset at step 601. At step 601, the server launches four multiple independent processes that operate at the same time. These processes, described as flows begin at steps 610, 620, 630, and 640, respectively, and each flow proceeds without reference or interference with other flows going on at the same time. Note that each flow it itself an endless cycle of steps, and each such cycle continues in perpetituity, or until the central server system is powered off.

The first cycle, beginning at step 610 is the process that waits for an attempted Internet connection from a remote appliance. In the event no remote appliance 104 is attempting to connect to the remote server, the cycle forever waits until there is an attempt. In the event there is an attempted connection, control passes to step 611 where the CPU 513 follows a program stored in memory 514 to authenticate the remote appliance. In a preferred embodiment of the invention, this is accomplished by examining the digitally signed X.509 digital certificate, in accordance with standard public key cryptography techniques. In any case, if the remote appliance is determined at step 612 to be authentic, then control passes to step 613 where any data files transferred from the remote appliance 104 to the central server 501 are saved on disk 531. After step 613, control passes to step 614 where the central server 501 allows the authenticated remote appliance to retrieve patches that may be ready, and yet unretrieved from the central server 501. After step 614 or in the event the remote appliance 104 failed to be properly authenticated, control passes to step 616 where the telephone connection to the Local ISP modem 111, and the Internet 113 connection to the central server 118 is terminated. Once terminated at step 616, the central server once again begins a cycle of waiting for a new remote appliance connection at step 610.

Another cycle, beginning at step 620 begins by having the CPU 513 of the central server 501 repeatedly checking the clock 512 against variables stored in memory 514 to determine if it is time to consolidate data received from one or more remote appliances. The time set for consolidation is set by the system operator using a browser 119 as needed to strike a balance between timely reports and excessive CPU 513 and disk 530, 531 activity. In any case, if it is not time to consolidate data, control remains at step 620 for this process until it is time. When the time to consolidate data arrives, at step 620, control passes to step 621 where the CPU 513 retrieves the scheduled dial-in times for each remote appliance from disk 530, passing control to step 622. At step 622, the CPU 513 retrieves the log files received from remote appliance activity, and at step 623 compares the expected, scheduled times for events to logged event times. The CPU 513 makes a decision at step 624 as to whether the remote appliance delivered all of the data expected in a timely manner. In the event all such data is delivered in a timely manner, correctly, control passes to step 627. In the event any data is not delivered in a timely manner or any data from any remote appliance is found to be missing or corrupt, the CPU passes control to step 625 to alert the system operator of the condition. After step 625, control passes to step 626 where the CPU 513 determines if any patches are needed in the remote appliances that reported untimely or corrupt data, and places those patches on the disk 513 for the remote appliance to retrieve between steps 442 and 443 as discussed above. Control then passes to step 627.

At step 627, the central server 501 proceeds to parse the received data files from one or more remote appliances that have deposited valid and timely data on the central server. The valid data is then stored in a database on the central server, saving the data on disk 531. After step 627 completes the parsing of received data files, step 628 deletes those data files in a preferred embodiment, saving disk space. Control is then passed back to step 620 where the central server system 501 waits for another time to consolidate additional data.

Step 630 represents the start of the process on the central server 501 to service requests from a user having a browser 119 and choosing to see reports based on the data consolidated from one or more remote appliances 104. At step 630 the central server 501 waits for an Internet connection, and in a preferred embodiment of the invention, this would be an HTTP message. The process commencing with step 630 continues in perpetituity waiting for such a connection until one is attempted by a browser 119. Only when a connection is attempted, does control pass to step 631 where the central server CPU collects the user identity and password information. The means of this authentication are varied, and only in a preferred embodiment are user identity and password information required. Other means of authenticating the user include the use of a mechanical token authenticator, or an exchange of X.509 certificates, or no authentication means at all. After collecting some authenticating information from the user, in a preferred embodiment, control passes to step 632 where the CPU 513 of the central server system 501 determines the authenticity of the credentials presented. If the credentials are not authentic, the user is asked to authenticate again in step 631. In the vent the credentials presented are authentic, control passes to step 633 where the CPU 513 presents to the browser 119 a menu of reports that the user may select from. These reports represent summaries of data collected from one or more remote appliances, and in a preferred embodiment of the invention include cash flow reports, inventory reports, credit card charges, accounts payable, and accounts receiveable. Control then passes to step 634 where the report or reports selected by the user are presented. After the reports are presented in step 634, the user may log-off deliberately or by virtue of inactivity for a long period of time such that control is passed to step 630 where the system waits for another user to log in. In the event the user does not log out at step 635 additional reports may be requested, since control is passed to step 633.

Step 640 represents a fourth process on the central server that begins a cycle of automatically preparing and delivering processed data to another system. In a preferred embodiment of the invention the other system is an accounting system on another server 120 that prints payroll checks on a printer 122. Messages are generated by the central server in this case would be XML encoded messages derived from processing the data consolidated from one or more remote appliances 104 connected to cash registers 101. At step 640, the central server system 501 perpetually waits for an appropriate time to begin processing data for transmitting to the accounting system 120. At the scheduled time, control passes to step 641 where the CPU 513 initiates an Internet connection through the dual Ethernet port 515 to another server 120. In a preferred embodiment of the invention, the protocol used is XML over HTTP such that the addressed server 120 is an XML gateway to a printer 122. However, other protocols could be used, including the SOAP protocol over HTTPS. Control then passes to step 642 where the CPU 513 and the XML gateway server 120 mutually authenticate the identity of each connected server, passing control to step 643.

At step 643, the central server system 501 and the CPU 513 in particular queries the database stored on disk 531 (as earlier described in step 627) and transmits detail and summary information in the form of XML messages to the XML gateway server 120, passing control to step 644. At step 644, upon the completion of scheduled database queries and XML message transmission, the database on the central server 501 is updated with the status of the actual transmission success. This update provides for electronic tracing of financial transactions, in a preferred embodiment of the invention, so that financial records made by the XML gateway 120, or checks printed by printer 122 may be traced to specific database entries on the central server 501. After step 644 control passes to step 645 where the CPU 513 makes a determination as to whether the database query and XML gateway transmissions to server 120 were successful. In the event these were not completely successful, an appropriate alert message is transmitted to the system operator at step 646. In the event the query and transmission was successful, or the alert has been completed at step 646, control passes to step 647 where the Internet connection to server 120 is terminated. At this point control of the process is returned to step 640 where the central server system 501 waits for another scheduled time to make transmissions based on new data.

The present system provides for data backup services. That is, each remote appliance periodically stores a data file that is periodically stored on the central server. In the event of a loss of data at the place of business 122, either the remote appliance 104 and/or the server 118 (in its database 117) contain a data file backup of copy that is then downloaded to the restore the data file to POS terminal 101.

1. In a remote appliance for coupling a data collection device to a central server, said central server being coupled to the Internet, said remote appliance having a port coupled to said data collection device, said remote appliance having the capability of connecting to the Internet, said remote appliance having a memory containing an encryption key, said data collection device storing a data file, said method comprising:
storing respective first and second polling schedules in said remote appliance;
polling said data collection device according to said first polling schedule;
storing a copy of said data file in said remote appliance in accordance with said first polling schedule;
connecting said remote appliance to the Internet in accordance with said second polling schedule;
identifying said remote appliance to said central server over the Internet using said encryption key; and
transferring said data file stored on said remote appliance to said central server.

2. A method in accordance with claim 1, said system further including an accounting server, said method further comprising:
connecting said accounting server to the Internet; and
transferring said data file stored on said central server to said accounting server,
whereby said accounting server has access to data collected at said data collection device.

3. A method in accordance with claim 1, where data collection device is a point of sale terminal.

4. A method in accordance with claim 1 where data collection device is a vending machine.

5. A method in accordance with claim 1, where data collection device is an employee time clock.

6. A remote appliance for coupling a data collection device to a central server, said data collection device storing a data file, said central server being coupled to the Internet, said remote appliance comprising:
a memory, said memory storing a first polling schedule, a second polling schedule and an encryption key;
a port coupled to said data collection device, said remote appliance polling said data collection device through said port according to said first polling schedule, said remote appliance receiving said data file through said port;
said memory further storing a copy of said data file in said remote appliance in accordance with said first polling schedule;
an Internet connection coupling said remote appliance to the Internet, said remote appliance connecting to the Internet in accordance with said second polling schedule;
said remote appliance adapted to send a message based on said encryption key to said central server over the Internet for identifying said remote appliance to said central server; and
said remote appliance adapted to transfer said data file stored on said remote appliance to said central server.

7. An apparatus in accordance with claim 6, wherein said system further comprises:
an accounting server, said accounting server connecting to the Internet for transferring said data file stored on said central server to said accounting server, whereby said accounting server has access to data collected at said data collection device.

8. An apparatus in accordance with claim 6, where data collection device is a point of sale terminal.

9. An apparatus in accordance with claim 6, where data collection device is a vending machine.

10. An apparatus in accordance with claim 6, where data collection device is an employee time clock.

11. In a system for viewing remote data on a personal computer running an Internet browser, said system having a remote appliance for coupling a data collection device to a central server, said central server being coupled to the Internet, said central server including a web site, said remote appliance having a port coupled to said data collection device, said remote appliance having the capability of connecting to the Internet, said remote appliance having a memory containing an encryption key, said data collection device storing a data file, said method comprising:
storing respective first and second polling schedules in said remote appliance;
polling said data collection device according to said first polling schedule;
storing a copy of said data file in said remote appliance in accordance with said first polling schedule;
connecting said remote appliance to the Internet in accordance with said second polling schedule;
identifying said remote appliance to said central server over the Internet using said encryption key;
transferring said data file stored on said remote appliance to said central server;
providing access to said data file on said web site stored on said central server,
connecting said personal computer to the Internet; and
accessing said web site on said central server with said personal computer;
whereby a user at said personal computer has access to data collected at said data collection device.

12. A method in accordance with claim 11, wherein said system further including an accounting server, said method comprising:
connecting said accounting server to the Internet;
transferring said data file stored on said central server to said accounting server,
whereby said accounting server has access to data collected at said data collection device.

13. A method in accordance with claim 11, where data collection device is a point of sale terminal.

14. A method in accordance with claim 11, where data collection device is a vending machine.

15. A method in accordance with claim 11, where data collection device is an employee time clock.

16. A network system comprising:
a data collection device for storing a data file;
a remote appliance coupled to said data collection device, said remote appliance comprising a memory storing an encryption key, a first polling schedule, a second polling schedule and an encryption key; said remote appliance further including a port coupled to said data collection device, said remote appliance adapted to receive said data file through said port in accordance with said first polling schedule and store said data file in said memory, said remote appliance having the capability of connecting to the Internet;
an Internet connection coupling said remote appliance to the Internet, said remote appliance connecting to the Internet in accordance with said second polling schedule;
a central server coupled to the Internet, said central server including a web site;
said remote appliance adapted to send a message based on said encryption key to said central server over the Internet for identifying said remote appliance to said central server;
said remote appliance adapted to transfer said data file stored on said remote appliance to said central server; and
a personal computer running an Internet browser, said personal computer being connected to the Internet and adapted for accessing said web site including said data file on said central server;
whereby a user at said personal computer has access to data collected at said data collection device.

17. An apparatus in accordance with claim 16, wherein said system further comprises:
an accounting server, said accounting server connecting to the Internet for transferring said data file stored on said central server to said accounting server, whereby said accounting server has access to data collected at said data collection device.

18. An apparatus in accordance with claim 16, where data collection device is a point of sale terminal.

19. An apparatus in accordance with claim 16, where data collection device is a vending machine.

20. An apparatus in accordance with claim 16, where data collection device is an employee time clock.

21. In a system for viewing remote data on a personal computer running an Internet browser, said system having a first and second remote appliances for coupling respective first and second data collection devices to a central server, said central server being coupled to the Internet, an accounting server, each of said first and second remote appliances having a respective first and second ports coupled to said first and second data collection devices respectively, each of said first and second remote appliances having the capability of connecting to the Internet and having respective first and second memories containing respective first and second encryption keys, said first and second data collection devices storing respective data files, said method comprising:
storing a copy of said first data file in said first remote appliance;
storing a copy of said second data file in said second remote appliance;
connecting said first remote appliance to the Internet;
transferring said first data file stored on said remote appliance to said central server;
connecting said second remote appliance to the Internet;
transferring said second data file stored on said remote appliance to said central server;
consolidating said first data file and second data file into a consolidated data file on said central server;
connecting said accounting server to the Internet;
transferring said consolidated data file on said central server to said accounting server,
whereby an accounting server is provided with consolidated data from data collected from said first data collection device and data collected from said second data collection device.

22. A method in accordance with claim 21, said central server further including a web site, said system further including a personal computer, said method comprising:
providing access to said consolidated data file on said web site stored on said central server;
connecting said personal computer to the Internet; and
accessing said web site on said central server with said personal computer;
whereby said personal computer has access to consolidated data collected at said first data collection device and said second data collection device.

23. A method in accordance with claim 21, where data collection device is a point of sale terminal.

24. A method in accordance with claim 21, where data collection device is a vending machine.

25. A method in accordance with claim 21, where data collection device is an employee time clock.

26. A network system comprising:
a first data collection device for storing a first data file;
a second data collection device for storing a second data file;
a first remote appliance coupled to said first data collection device, said first remote appliance comprising a first memory, said remote appliance further including a first port coupled to said first data collection device, said first remote appliance adapted to receive said first data file through said first port and store said first data file in said memory, said first remote appliance having the capability of connecting to the Internet;
a second remote appliance coupled to said second data collection device, said second remote appliance comprising a second memory, said remote appliance further including a second port coupled to said second data collection device, said second remote appliance adapted to receive said second data file through said second port and store said second data file in said memory, said second remote appliance having the capability of connecting to the Internet;
an Internet connection coupling said first remote appliance to the Internet;
an Internet connection coupling said second remote appliance to the Internet;
a central server coupled to the Internet, said central server including a web site;
said first remote appliance adapted to transfer said first data file stored on said first remote appliance to said central server;
said second remote appliance adapted to transfer said second data file stored on said second remote appliance to said central server;
said central server providing a consolidated data file by combining data from said first data file and data from said second data file into a consolidated data file; and
an accounting server, said accounting server connecting to the Internet for transferring said consolidated data file stored on said central server to said accounting server,
whereby said accounting server has access to data collected at said first data collection device and said second data collection device.

27. An apparatus in accordance with claim 26, wherein said system further comprises:
a personal computer running an Internet browser, said personal computer being connected to the Internet and adapted for accessing said web site including said consolidated data file on said central server;
whereby a user at said personal computer has access to data collected at said first data collection device and said second data collection device.

28. An apparatus in accordance with claim 26, where data collection device is a point of sale terminal.

29. An apparatus in accordance with claim 26, where data collection device is a vending machine.

30. An apparatus in accordance with claim 27, where data collection device is an employee time clock.

31. In a system for viewing remote data on a personal computer running an Internet browser, said system having a first and second remote appliances for coupling respective first and second data collection devices to a central server, said central server being coupled to the Internet, a first accounting server, a second accounting server, each of said first and second remote appliances having respective first and second memories and a respective first and second ports coupled to said first and second data collection devices respectively, each of said first and second remote appliances having the capability of connecting to the Internet, said method comprising:
storing a copy of said first data file in said first memory of said first remote appliance;
storing a copy of said second data file in said second memory of said second remote appliance;
connecting said first remote appliance to the Internet;
transferring said first data file stored on said first remote appliance to said central server;
connecting said second remote appliance to the Internet;
transferring said second data file stored on said second remote appliance to said central server;
connecting said first accounting server to the Internet;
transferring said first data file stored on said central server to said first accounting server,
connecting said second accounting server to the Internet;
transferring said second data file stored on said central server to said second accounting server,
whereby said server provides said first accounting server with data collected from said first data collection device and said server provides said second accounting server with data collected from said second data collection device.

32. A method in accordance with claim 31, wherein said system further including a first personal computer and a second personal computer, said method comprising:
providing access to said first data file on said web site stored on said central server;
connecting said first personal computer to the Internet and accessing said first data file on said web site;
providing access to said second data file on said web site stored on said central server;
connecting said second personal computer to the Internet and accessing said second data file on said web site;
whereby said first personal computer has access to said first data collected at said first data collection device and said second personal computer has access to said second data collected at said second data collection device.

33. A method in accordance with claim 32, where data collection device is a point of sale terminal.

34. A method in accordance with claim 32, where data collection device is a vending machine.

35. A method in accordance with claim 32, where data collection device is an employee time clock.

36. A network system comprising:
a first data collection device for storing a first data file;
a second data collection device for storing a second data file;
a first remote appliance coupled to said first data collection device, said first remote appliance comprising a first memory, said remote appliance further including a first port coupled to said first data collection device, said first remote appliance adapted to receive said first data file through said first port and store said first data file in said memory, said first remote appliance having the capability of connecting to the Internet;
a second remote appliance coupled to said second data collection device, said second remote appliance comprising a second memory, said remote appliance further including a second port coupled to said second data collection device, said second remote appliance adapted to receive said second data file through said second port and store said second data file in said memory, said second remote appliance having the capability of connecting to the Internet;
an Internet connection coupling said first remote appliance to the Internet;
an Internet connection coupling said second remote appliance to the Internet;
a central server coupled to the Internet, said central server including a web site;
said first remote appliance being adapted to transfer said first data file stored on said first remote appliance to said central server;
said second remote appliance being adapted to transfer said second data file stored on said second remote appliance to said central server;
a first accounting server, said first accounting server connecting to the Internet and being adapted for transferring said first data file stored on said central server to said first accounting server, and
a second accounting server, said second accounting server connecting to the Internet and being adapted for transferring said second data file stored on said central server to said second accounting server,
whereby said first accounting server has access to data collected at said first data collection device and said second accounting server has access to data collected at said second data collection device.

37. An apparatus in accordance with claim 36, wherein said system further comprises:
a personal computer running an Internet browser, said personal computer being connected to the Internet and adapted for accessing said web site including said consolidated data file on said central server;
whereby a user at said personal computer has access to data collected at said first data collection device and said second data collection device.

38. An apparatus in accordance with claim 36, where data collection device is a point of sale terminal.

39. An apparatus in accordance with claim 36, where data collection device is a vending machine.

40. An apparatus in accordance with claim 36, where data collection device is an employee time clock.
